(19) United States
(12) Patent Application Publication
(10) Pub. No.: US 2008/0097942 A1
(43) Pub. Date: Apr. 24, 2008

(54) System and Method for Automated Suspicious Object Boundary Determination

(75) Inventors: Luyin Zhao, White Plains, NY (US); James D. Schaffer, Wappingers Falls, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,605

(22) PCT Filed: Jul. 21, 2005
(86) PCT No.: PCT/IB05/52445

§ 371 Date: Jan. 24, 2007

Related U.S. Application Data
(60) Provisional application No. 60/591,075, filed on Jul. 26, 2004.

(51) Int. Cl. G06N 3/12; G06F 15/18

(52) U.S. Cl. 706/13

(57) ABSTRACT

A system and method is provided for automated suspicious object boundary determination using a machine learning system (300) and genetic algorithms. The machine learning system (300) is trained (204) and tested (205) using sets of pre-categorized examples. Genetic algorithms assign initial parameter values (201), evaluate the system's performance (206) during testing and assign a performance rating (207), whereupon if the rating is acceptable, the current machine learning system's settings are assigned as default parameters (209) for future suspicious object segmentation. However, if the performance rating is unacceptable, the genetic algorithms adjust the settings (210) and retrain the system using the newly adjusted settings.

The present invention relates, generally, to systems and methods for determining suspicious object boundaries in tissues and more specifically, to automated systems and methods of suspicious object boundary determination.

Computer aided detection (CAD) and computer aided diagnosis (CADx) are computer based approaches for suspicious object detection and diagnosis. These approaches are supposed to perform better than traditional visual inspection by a radiologist due to the capability of the computerized systems to “see” detailed characteristics in medical diagnostic images of suspicious objects much more accurately. Additionally, researchers have been continuously improving algorithms for CAD and CADx.

While many algorithms have been developed for detecting suspicious objects using CAD, performing effective automatic suspicious object segmentation presents significant challenges since the boundary of a suspicious object is very difficult to detect, thus, these algorithms usually provide boundary adjustment capabilities for radiologists to determine the actual boundary. Although this does not seem to cause too much inconvenience for radiologists, it does cause difficulties for CADx.

Traditionally CADx is performed after CAD is completed and makes use of the output from CAD—especially suspicious object segmentation data—as inputs, thus employing a CAD system that more correctly detects the boundaries of suspicious objects directly impacts, beneficially, the success rate of the CADx system. Using the CAD output data, the CADx system generates certain classifiers. The CADx system employs various classification schemes, such as artificial neural network, Bayesian, decision tree, etc. on the CAD data to arrive at a diagnosis. By properly training theses classification schemes (i.e., machine learning systems), in an objective manner, the resulting diagnostic success rate is improved.

The current suspicious object detection algorithms have a common problem regarding suspicious object segmentation, in that it is impossible for the algorithms to provide a precise boundary definition for any given suspicious object. The reason is simple; the boundary between suspicious object and surrounding tissue is not clear-cut. There is no definitive threshold or algorithm to differentiate suspicious object pixels with boundary pixels. What an algorithm can do is offer a parameter adjustment feature (with certain possibly optimal default parameter values) for radiologists to determine the suspicious object boundary. Therefore, the capability of a computer to segment suspicious object from digital images becomes limited and highly dependent on the individual radiologist's own judgment.

A group of algorithms that is finding favor in the area of computational modeling is the family of algorithms known as genetic algorithms. Genetic algorithms encode solutions using a chromosome inspired data structure and apply recombination operators to these structures in a manner that preserves critical information.

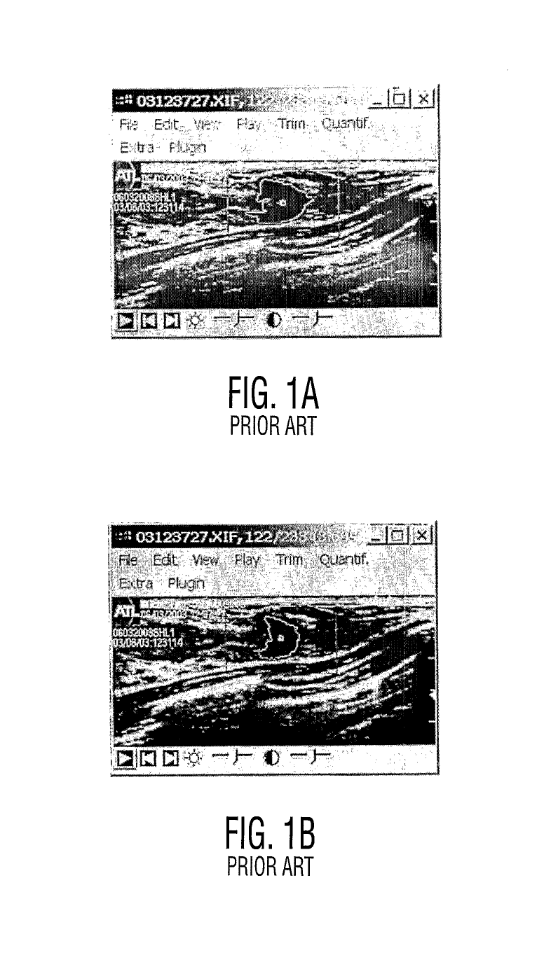

FIGS. 1a and 1b show a breast cancer tumor segmented by the FastMarch algorithm. As shown by FIGs. la and lb, by adjusting parameters, the detected shape of the tumor can change dramatically. Such freedom of segmentation would bring the following problems:

(1) It impedes automatic suspicious object segmentation and automatic report generation.

(2) It complicates CADx operations. CADx first trains a computer using a set of examples containing suspicious objects with a known nature (malignant/benign), also referred to herein as a ground truth. However, if the segmentation of these training examples is arbitrarily determined by a radiologist, the machine learning based on these training examples might not generate maximum performance for diagnosing new suspicious objects.

The system and method of the present invention overcome such problems by establishing an optimal set of default values for relevant segmentation parameters of training data and these values could be applied to new suspicious objects consistently for segmentation/diagnosis.

The system and method of the present invention provide a combination of machine learning and genetic algorithm techniques for suspicious object boundary determination.

The idea of using machine learning (e.g. artificial neural network, Bayesian method, decision tree, etc.) is to learn from a large number of examples with ground truth (normally whether a nodule is malignant or benign) in order for the computer to predict the nature of a new suspicious object. The output of such prediction would be either benign/malignant or a likelihood of malignancy.

Assuming that the suspicious object diagnostics system has five adjustable parameters, theoretically, each possible combination of values would be tested (exhaustive approach) on the whole training dataset to see whether such segmentation could lead to a closest match between machine prediction capability and known ground truth. However, since in practice the range of parameter values is very large, it is usually impossible to run such an algorithm within a tolerable time limit. Therefore, the present invention uses genetic algorithms to reach a near optimal solution in a reasonable time.

Embodiments of the present invention provide a system and method for automated suspicious object boundary determination using machine learning and genetic algorithms. The system and method include at least one training set of suspicious object identification images, which are initially segmented using a set of randomly generated parameter values. However, parameter values may also be selected from a stored set of preferred values. The segmented suspicious object identification images are processed using image feature extraction algorithms to produce input data for a machine learning system. Subsequently, the machine learning system is tested using at least one testing set of suspicious object identification images. Performance of the machine learning system is evaluated by comparing the outputs produced during testing against known ground truths of the testing set. The performance level is determined based on the amount of difference occurring between the outputs and the ground truths and passed to the genetic algorithm to be used as a measure of the fitness of the parameter set being evaluated.

Acceptability of the performance level is determined (based on presets) and used by a genetic algorithm to decide whether to continue or halt. If the performance level is acceptable, the parameter values are set as default values for use in automatic segmentation, however, if the performance level is unacceptable, the genetic algorithm adjusts the parameter values and performs the method steps again using the adjusted parameter values in place of the previous parameter values.

The system includes a processor configured for performing the method as described above, as well as input devices (e.g., keyboard, mouse, etc), a hard drive and/or optical storage device and a display screen. Optionally, a graphical user interface may be provided.

A further embodiment of the present invention may be a software application, suite of software tools, or computer executable instructions for performing the above-described method on a personal computer, workstation, server or other computing device. The software may be stored on a computer-readable medium such as magnetic media, optical media, memory cards, and ROMs.

Additionally, the software may be executable across a network. In such a case, the software is stored on a server networked to one or more workstations. The workstations provide an operator the ability to control the software executed on the server.

These and other features, aspects, and advantages of the present invention will become better understood with regard to the following description, and accompanying drawings wherein:

FIGS. 1a and 1b are illustrations of prior art segmentation of a breast cancer suspicious object using two different sets of parameter values;

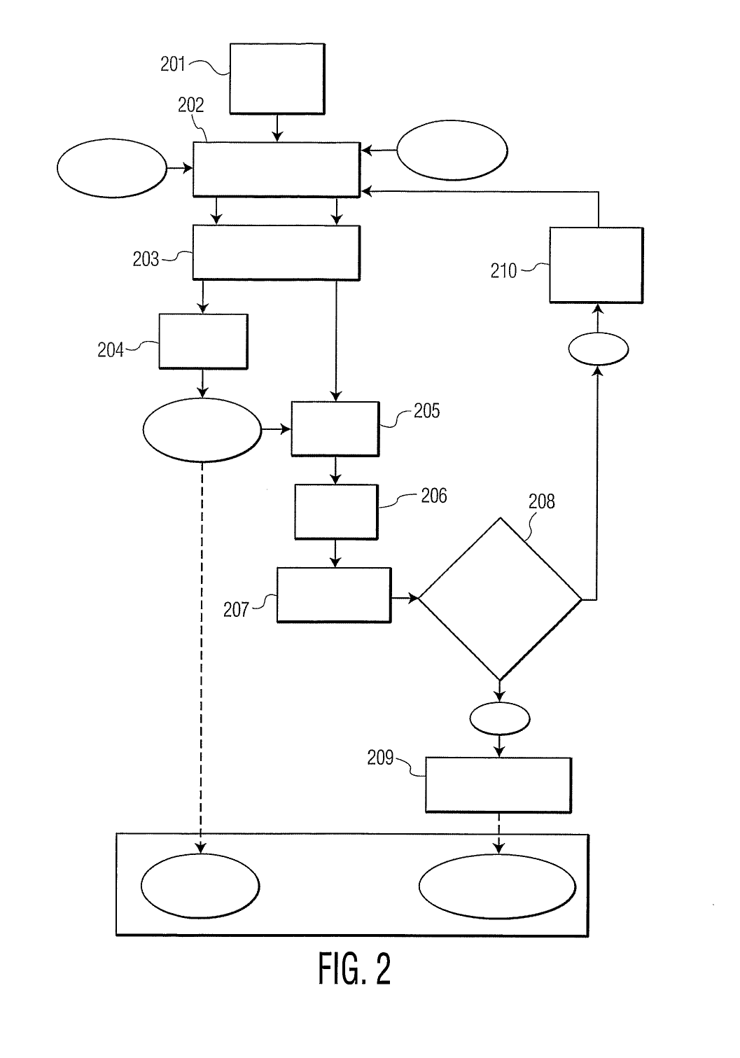

FIG. 2 is a flowchart illustrating the steps in performing an embodiment of the present invention;

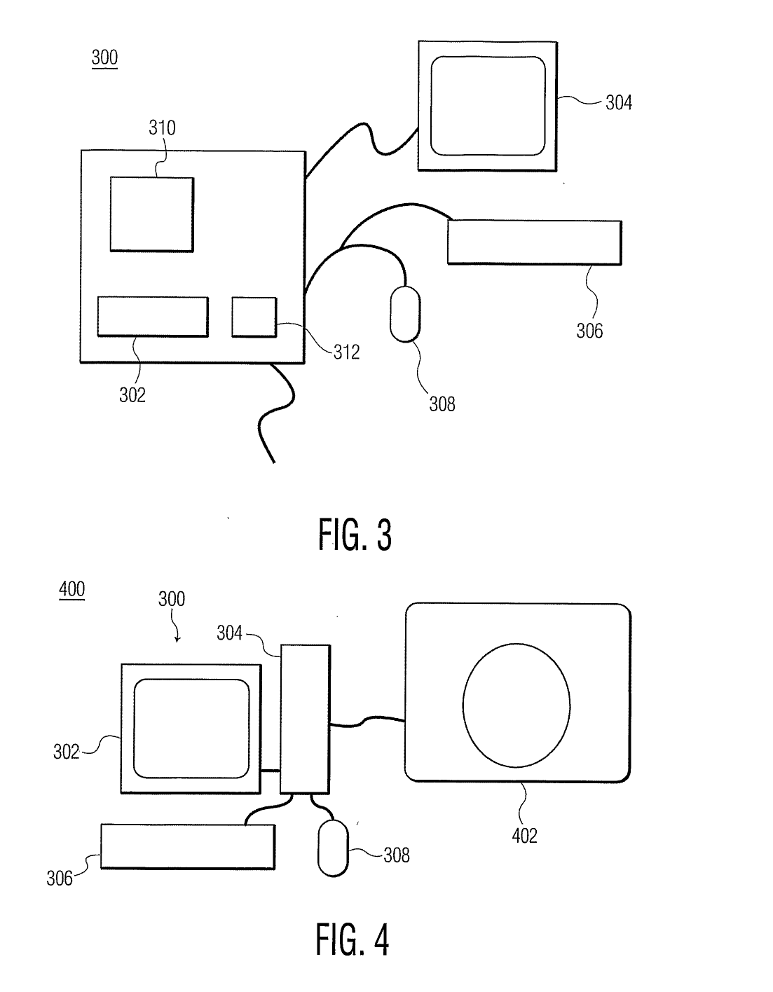

FIG. 3 is an illustration of a suspicious object diagnostic system in accordance with the present invention;

FIG. 4 is an illustration of an integrated medical imaging and diagnostic system in accordance with the present invention;

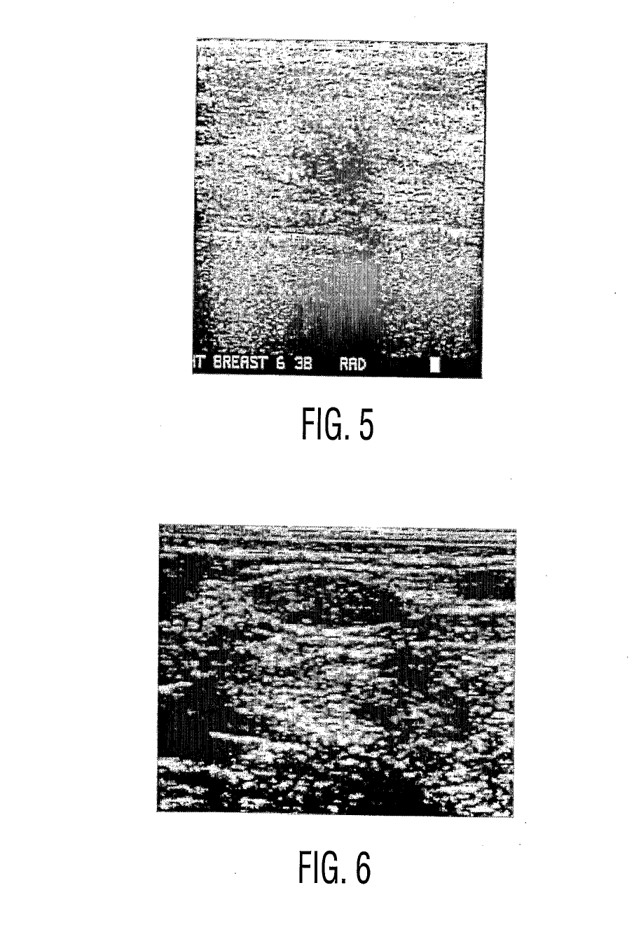

FIG. 5 is an image of a training example showing a malignant suspicious object for training the diagnostic system in accordance with the present invention; and

FIG. 6 is an image of a training example showing a benign suspicious object for training the diagnostic system in accordance with the present invention.

An embodiment of the present invention performs the steps as shown in FIG. 2. The process begins with step 201, wherein a set of randomly generated parameter values is selected. The set of randomly generated parameter values is utilized to perform suspicious object segmentation of a set of training examples in Step 202. The training examples, as shown in FIGS. 5 and 6, are of previously characterized suspicious objects and have corresponding ground truth records, which are used in a later step to rate performance of the suspicious object boundary determination system. The ground truths may include such information as malignancy, shape/contour of the suspicious object, etc. In step 203, the segmented suspicious objects are processed by image feature extraction algorithms. Some examples of image features that are applicable include boundary perimeter length, area of a superimposed and fitted circle or oval, roughness of boundary edge, brightness gradient, etc. In step 204, the generated features and characteristics data outputted from step 203 along with the ground truth records are entered in to a machine learning system or classifier (e.g. a neural network). The outputs from the classifier are tested on a set of testing examples (another set of suspicious objects that are segmented, and feature-extracted like the training data) in step 205. Subsequently in step 206, the testing results (predicted likelihood of malignancy) are compared with ground truth records for the set of testing examples. The actual ground truth data and the testing results are compared and the difference is treated as the performance rating (the lower the difference, the better the performance) in step 207. In step 208, it is determined whether the performance rating is acceptable based on presets. If the performance rating is deemed acceptable, then the genetic algorithm is stopped and the current set of parameter values is used as default values for automatic segmentation, along with the trained classifier that works best with it in step 209. However, if the performance rating is not acceptable, a genetic algorithm adjusts the parameters using any of several methods (e.g. mutation and crossover) in step 210 and the whole process continues from step 202.

Overall the inventive method for automated suspicious object boundary determination using machine learning and at least one genetic algorithm includes the steps of providing at least one training set of suspicious object identification images, wherein the at least one training set are segmented using a set of chosen or randomly generated parameter values; and processing the segmented suspicious object identification images using image feature extraction algorithms to produce input data for a machine learning system. The method further includes the steps of testing the machine learning system using at least one testing set of suspicious object identification images and evaluating performance of the machine learning system. Outputs produced in the testing step are compared against known ground truths of the testing set (i.e. cross validation). The performance level is determined based on the number and/or sizes of differences occurring between the outputs and the ground truths. The method also includes the step of determining acceptability of the performance level based on pre-sets. If the performance level is acceptable, the genetic algorithm terminates and the parameter values are set as default values for use in automatic segmentation and the trained classifier that works with them is set. If the performance level is unacceptable, the genetic algorithm adjusts the parameter values and performs these method steps again starting at the providing step using the adjusted parameter values in place of the previous randomly generated parameter values.

An additional embodiment of the present invention, as shown in FIG. 3, provides a computer system 300 having a processor 302, display screen 304 and input devices, such as a keyboard 306 and mouse 308. Additionally, the system 300 includes at least mass storage device 310, e.g., hard drive, CD-Rom, optical storage, etc. The system may also have a networking interface 312, such as 10/100/1000 Base-T or wireless IEEE 802.11a/b/c.

The computer system 300 is configured to execute computer-readable instructions for performing the method as described above. The instructions may be stored on the mass storage device 310 or on a removable media readable by the mass storage device. In addition, the instructions may be downloadable from a network—either a LAN or Internet—or executable across a network.

Yet another embodiment of the present invention provides for a complete medical diagnostic system 400 as shown in FIG. 4. The medical diagnostic system 400, includes one or more medical imaging systems 402, e.g. ultrasound imaging, Magnetic Resonance Imaging, X-Ray, etc., and the computer system 300 as described above. Such a medical diagnostic system 400 provides an integrated solution for suspicious object imaging, segmentation and diagnosis.

Overall the inventive system for automated suspicious object boundary determination utilizing a machine learning system and at least one genetic algorithm, includes at least one training set of suspicious object identification images. The at least one training set is segmented using a set of randomly generated parameter values. The system further includes at least one image feature extraction algorithm for processing the segmented suspicious object identification images to produce input data for the machine learning system; and at least one testing set of suspicious object identification images for testing outputs of the machine learning system. The at least one genetic algorithm evaluates results from the at least one testing set for determining a performance level for the machine learning system. If the performance level is acceptable, the parameter values are set as default values for use in automatic segmentation. If the performance level is unacceptable, the genetic algorithm adjusts the parameter values.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

1. A method for automated suspicious object boundary determination using machine learning and at least one genetic algorithm, said method comprising the steps of:
providing at least one training set of suspicious object identification images, wherein said at least one training set are segmented (202) using a set of initial parameter values (201);
processing said segmented suspicious object identification images using image feature extraction algorithms (203) to produce input data for a machine learning system;
testing said machine learning system (205) using at least one testing set of suspicious object identification images;
evaluating performance of said machine learning system (206), wherein outputs produced in said testing step are compared against known ground truths of said testing set, said performance level is determined based on the amount of difference occurring between said outputs and said ground truths; and
determining acceptability of said performance (207) level based on pre-sets, said determination is performed by said at least one genetic algorithm, if said performance level is acceptable (209) said parameter values are set as default values for use in automatic segmentation, if said performance level is unacceptable (210) said genetic algorithm adjusts said parameter values and performs said method steps starting at said providing step using said adjusted parameter values in place of said randomly generated parameter values.

2. The method of claim 1, wherein the initial parameter values (201) are randomly generated.

3. The method of claim 1, wherein the initial parameter values (201) are generated by an operator skilled in the use of the segmentation algorithm.

4. The method of claim 1, wherein the initial parameter values (201) are a combination of randomly generated and operator generated values.

5. The method of claim 1, wherein said machine learning system utilizes at least one of a neural network, naive Bayesian classifier, Bayesian network, decision tree, support vector machine, linear or non-linear discriminant function.

6. The method of claim 1, wherein said feature extraction algorithm is configured for extracting (203) one or more features select from the group consisting of: boundary perimeter length, area of a superimposed and fitted circle or oval, roughness of boundary edge and brightness gradient.

7. The method of claim 1, wherein said parameter values (201) are provided for any one or more of the parameters in the group consisting of: seed point location in a region of interest (ROI), segmentation algorithm, image pre-processing, attenuation compensation, and boundary halting criteria.

8. A system for automated suspicious object boundary determination utilizing a machine learning system (300) and at least one genetic algorithm, said system comprising:
at least one training set of suspicious object identification images, wherein said at least one training set is segmented using a set of initial parameter values;
at least one image feature extraction algorithm for processing said segmented suspicious object identification images to produce input data for said machine learning system (300);
at least one testing set of suspicious object identification images for testing outputs of said machine learning system (300); and
said at least one genetic algorithm for evaluating results from said at least one testing set for determining a performance level for said machine learning system (300), if said performance level is acceptable said parameter values are set as default values for use in automatic segmentation, if said performance level is unacceptable said genetic algorithm adjusts said parameter values.

9. The system of claim 8, wherein the initial parameter values are randomly generated.

10. The method of claim 8, wherein the initially generated parameter values are generated by a human skilled in the use of the segmentation algorithm.

11. The method of claim 8, wherein the initially generated parameter values are a combination of randomly generated and human generated values.

12. The system of claim 8, wherein said machine learning system utilizes at least one of a neural network, Bayesian, and decision tree.

13. The system of claim 8, wherein said system is retrained and retested until an acceptable performance level is obtained.

14. The system of claim 8, wherein said feature extraction algorithm is configured for extracting one or more features select from the group consisting of: boundary perimeter length, area of a superimposed and fitted circle or oval, roughness of boundary edge and brightness gradient.

15. The system of claim 8, further comprising a medical imaging device (402) for imaging a patient and providing said imaged data to said machine learning system (300) for subsequent segmentation and diagnosis.

16. The system of claim 15, wherein said medical imaging device (402) is selected from a group consisting of MRI, ultrasound and X-Ray imaging systems.

17. A computer-readable medium storing a plurality of computer-executable instructions for performing automated suspicious object boundary determination, said instructions configured for performing the steps of:
generating a set of initial parameter values (201);
providing at least one training set of suspicious object identification images, wherein said at least one training set are segmented (202) using said set of randomly generated parameter values;
processing said segmented suspicious object identification images using image feature extraction algorithms (203) to produce input data for a machine learning system (300);
testing said machine learning system using at least one testing set of suspicious object identification images (205);
evaluating performance of said machine learning system (300), wherein outputs produced in said testing step are compared (206) against known ground truths of said testing set, said performance level is determined (207) based on the number of differences occurring between said outputs and said ground truths; and
determining acceptability of said performance level (208) based on pre-sets, said determination is performed by at least one genetic algorithm, if said performance level is acceptable said parameter values are set as default values (209) for use in automatic segmentation, if said performance level is unacceptable said at least one genetic algorithm adjusts said parameter values (210) and performs said method steps starting at said providing step using said adjusted parameter values in place of said randomly generated parameter values.

18. The computer-readable medium of claim 17, wherein said computer-readable medium is selected from the group consisting of magnetic media, optical media, memory card and ROM.

19. The computer-readable medium of claim 17, wherein said instructions are executable across a network.

20. A suspicious object boundary determination system using machine learning and at least one genetic algorithm, said system comprising:
means for providing at least one training set of suspicious object identification images, wherein said at least one training set are segmented (202) using a set of randomly generated parameter values (201);
means for processing said segmented suspicious object identification images using image feature extraction (203) algorithms to produce input data for a machine learning system (300);
means for testing (205) said machine learning system (300) using at least one testing set of suspicious object identification images;
means for evaluating performance of said machine learning system (300), wherein outputs produced in said testing step are compared (206) against known ground truths of said testing set, said performance level is determined (207) based on the number of differences occurring between said outputs and said ground truths; and
means for determining acceptability of said performance level (208) based on pre-sets, said determination is performed by said at least one genetic algorithm, if said performance level is acceptable said parameter values are set as default values for use in automatic segmentation (209), if said performance level is unacceptable said genetic algorithm adjusts said parameter values (210) and performs said method steps starting at said providing step using said adjusted parameter values in place of said randomly generated parameter values.

21. The system of claim 20, wherein said machine learning system (300) utilizes at least one of a neural network, Bayesian, and decision tree.

22. The system of claim 20, wherein said system is retrained (204) and retested (205) until an acceptable performance level is obtained (209).

23. The system of claim 20, wherein said feature extraction algorithm is configured for extracting one or more features selected from the group consisting of: boundary perimeter length, area of a superimposed and fitted circle or oval, roughness of boundary edge and brightness gradient.

24. The system of claim 20, further comprising a means for imaging a patient (402) and providing said imaged data to said machine learning system (300) for subsequent segmentation and diagnosis.

25. The system of claim 24, wherein said imaging means (402) is selected from a group consisting of MRI, ultrasound and X-Ray imaging systems.
